(19) United States
(12) Patent Application Publication
(10) Pub. No.: US 2012/0105435 A1
(43) Pub. Date: May 3, 2012

(54) Apparatus and Method for Inpainting Three-Dimensional Stereoscopic Image

(75) Inventors: Hsin-Jung Chen, Jiaoxi Township (TW); Feng-Hsiang Lo, Jhubei City (TW); Sheng-Dong Wu, Zhonghe City (TW); Ming-Yu Lin, Dadu Township (TW)

(73) Assignee: INDUSTRIAL TECHNOLOGY RESEARCH INSTITUTE, Hsinchu (TW)

(21) Appl. No.: 13/032,729

(22) Filed: Feb. 23, 2011

(30) Foreign Application Priority Data
Nov. 3, 2010 (TW) 99137867

(51) Int. Cl. G06T 15/00

(52) U.S. Cl. 345/419

(57) ABSTRACT

An apparatus and a method for rendering three-dimensional stereoscopic images are provided. The apparatus is for use in a three-dimensional image processing system which generates viewpoint images according to an input image and an input depth. The apparatus comprises an object device, a depth device, and a block filling device. The object device executes a process of object detection to output contour information according to the input image. The depth device executes a process of object judgment to output distance information according to the input depth. The block filling device detects a hole region in each viewpoint image, searches a search region adjacent to the hole region for a number of original pixels, and fills the hole region according to the original pixels, the contour information, and the distance information.

### RELATED APPLICATION

This application claims the benefit of Taiwan application Serial No. 99137867, filed Nov. 3, 2010, the subject matter of which is incorporated herein by reference.

### TECHNICAL FIELD

The disclosure relates in general to an apparatus and a method for rendering images, and more particularly to an apparatus and a method for rendering three-dimensional stereoscopic images.

### BACKGROUND

With the advance of the technique made in image process, the presentation of visual effect has been gradually brought from two-dimensional plane into three-dimensional space. As regards an input image, processes of generating a three-dimensional image can be classified into two main categories. In a process of a first category where several video cameras are used, the video cameras are positioned at different viewing angles to photograph the same objects, thus obtaining a number of two-dimensional images. In this way, as for the object which is to be presented in three-dimensional space, a number of viewpoint images such as the two-dimensional images captured at different angles can have their image information combined to synthesize a multi-view three-dimensional stereoscopic image.

In a process of a second category where a single video camera is used, the single video camera is positioned at a fixed viewing angle to photograph objects, thus obtaining a single two-dimensional image. In addition, a depth image corresponding to the two-dimensional image is provided to carry distance information of each object in the two-dimensional image. From the depth image, it can be derived that which object is located in the front of the two-dimensional image, i.e., in the front of the frame, and, in contrast thereto, which object is located in the rear of the two-dimensional image, i.e., in the rear of the frame. Therefore, the contained information of the two-dimensional image and the depth image can also be used to synthesize a multi-view three-dimensional stereoscopic image.

As is mentioned above, a single two-dimensional image along with its depth image can result in the generation or synthesis of a multi-view three-dimensional stereoscopic image. In the course of synthesis, a number of viewpoint images are generated and converted into a final image for outputting. Based on the depth image, shifts of image pixels to a new viewing angle are constructed to generate a viewpoint image which a viewer can observe from that viewing angle. However, the generated viewpoint image is not certainly an image with complete, intact image information. In other words, there could be holes remained in some region of the viewpoint image, and objects in the viewpoint image have some of their parts lost.

Refer to both FIGS. 1A, 1B, 1C, 1D, and 1E. FIG. 1A is a schematic diagram showing an original viewpoint image when observed from a center position. FIGS. 1B and 1C are schematic diagrams each showing a shifted viewpoint image when observed from a left position. FIGS. 1D and 1E are schematic diagrams each showing a shifted viewpoint image when observed from a right position. Viewpoint images 10a, 10b, 10c, 10d, and 10e are indicative of five viewpoint images which a viewer can observe at different viewing angles. The viewpoint image 10a is referred to as a viewpoint image at a central viewing angle, a two-dimensional image which is input originally without having its image pixels shifted. The viewpoint images 10b and 10c each are a shifted viewpoint image at a left viewing angle, while the viewpoint images 10d and 10e at a right viewing angle. Objects 110 and 120 in the images are represented by a triangular pattern and a square pattern, respectively. The objects 110 and 120 are in front of a label 140 indicative of background. The objects 110 and 120 have their location spatially correlated with each other. The object 110 is referred to as a foreground object since it is closer to the viewer, and the object 120 is referred to as a background object since it is behind the object 110.

When the viewer moves toward his or her left-hand side, the images he or she will see are illustrated by the viewpoint images 10b and 10c. In the viewpoint image 10b, a hole region 130b as denoted by slash marks “I” is appeared on the left side of the object 110. The reason the holes remain in the generated images is that the original two-dimensional image does not contain the image information of the hole regions 130b and 130c. Each of the hole regions 130b and 130c is indicative of a shift in relation to its base which is the viewpoint image 10a in this example. This can be also known as parallax difference which is caused when the viewer moves his or her position. In this regard, the hole regions 130b and 130c are where the view should see behind the object 110 but their true image information are absent in the original two-dimensional image, with the result that the hole regions 130b and 130c are generated. Similarly, in the viewpoint image 10d, a hole region 130d as denoted by slash marks “/” is appeared on the right side of the object 110. In the viewpoint image 10e, a hole region 130e as denoted by slash marks “/” is appeared on the right side of the object 110.

In addition to generating holes on left and right sides in the left and right viewpoint images, among those viewpoint images shifted toward the same direction, a viewpoint image, if corresponding to a larger distance between its viewing angle and the central viewing angle, has a hole region more obvious or wider than another. For example, the viewpoint images 10b and 10c are both left viewpoint images. Between them, the viewpoint image 10b has a larger distance between its viewing angle and the central viewing angle, so that its hole region 130b is more obvious than the hole region 130c. This means that the viewpoint image 130b can be found therein more image information which is absent in the original two-dimensional image. Similar situation applies to the viewpoint images 10e and 10d. Between them, the viewpoint image 10e has a larger distance between its viewing angle and the central viewing angle, so that its hole region 130e is more obvious than the hole region 130d.

### SUMMARY

According to an embodiment, an apparatus is provided for rendering three-dimensional stereoscopic images. The apparatus is for use in a three-dimensional image processing system which generates a number of viewpoint images according to an input image and an input depth. The apparatus includes an object device, a depth device, and a block filling device. The object device executes a process of object detection to output contour information according to the input image. The depth device executes a process of object judgment to output distance information according to the input depth. The block filling device detects a hole region in each viewpoint image, searches a search region adjacent to the hole region for a number of original pixels, and fills the hole region according to the original pixels, the contour information, and the distance information.

According to another embodiment, a method is provided for rendering three-dimensional stereoscopic images. The method is for use in a three-dimensional image processing system which generates a number of viewpoint images according to an input image and an input depth. The method includes a number of steps. A hole region in each of the viewpoint images is detected. A process of object detection is executed to output contour information according to the input image. A process of object judgment is detected to output distance information according to the input depth. A search region adjacent to the hole region is researched for a number of original pixels. The hole region is filled according to the original pixels, the contour information, and the distance information.

The above and other aspects of the disclosure will become better understood with regard to the following detailed description of the preferred but non-limiting embodiment(s). The following description is made with reference to the accompanying drawings.

### BRIEF DESCRIPTION OF THE DRAWINGS

FIG. 1A is a schematic diagram showing an original viewpoint image when observed from a center position.

FIGS. 1B and 1C are schematic diagrams each showing a shifted viewpoint image when observed from a left position.

FIGS. 1D and 1E are schematic diagrams each showing a shifted viewpoint image when observed from a right position.

FIG. 2 is a block diagram showing an exemplary embodiment of a three-dimensional image processing system.

FIG. 3 is a flow chart showing a method for rendering three-dimensional stereoscopic image according to an exemplary embodiment.

FIG. 4A is a schematic diagram showing a viewpoint image where a hole is generated after the shift of the input image.

FIG. 4B is a partially enlarged diagram showing a selected portion 450 in FIG. 4A.

FIG. 4C is a partially enlarged diagram showing the selected portion in FIG. 4B where the hole region is filled by proportionate expansion.

FIG. 4D is a schematic diagram showing a viewpoint image in FIG. 4A where the hole region is filled by proportionate expansion.

FIG. 5A is a schematic diagram showing the selected portion in FIG. 4B where the hole region is filled by using a variation criteria of the object.

FIG. 5B is a schematic diagram showing a viewpoint image in FIG. 4A where the hole region is filled by using the variation criteria of the object.

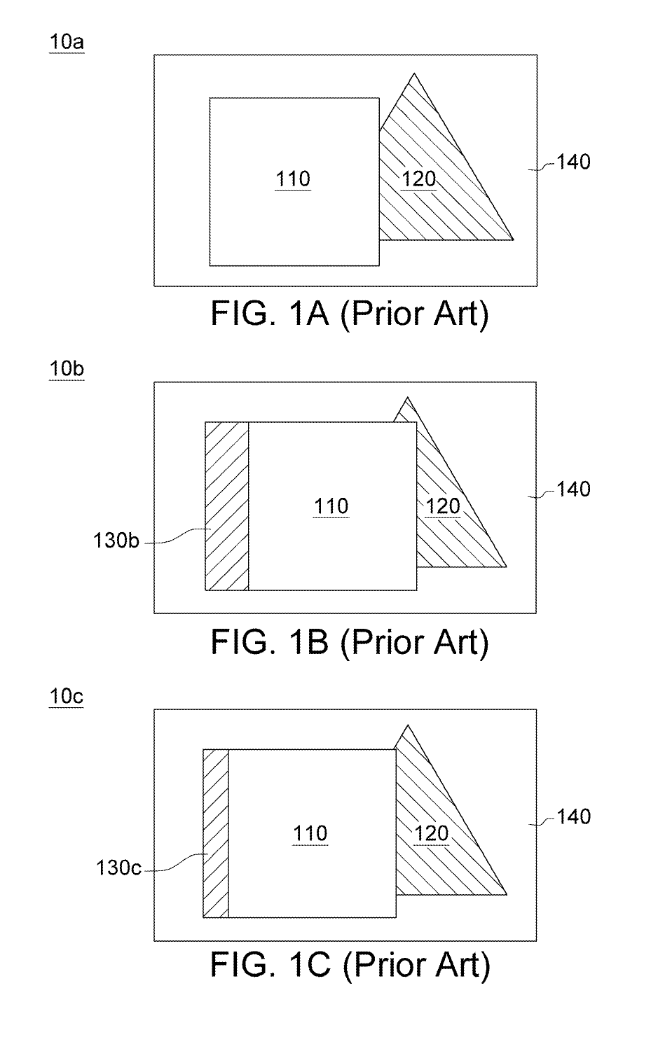

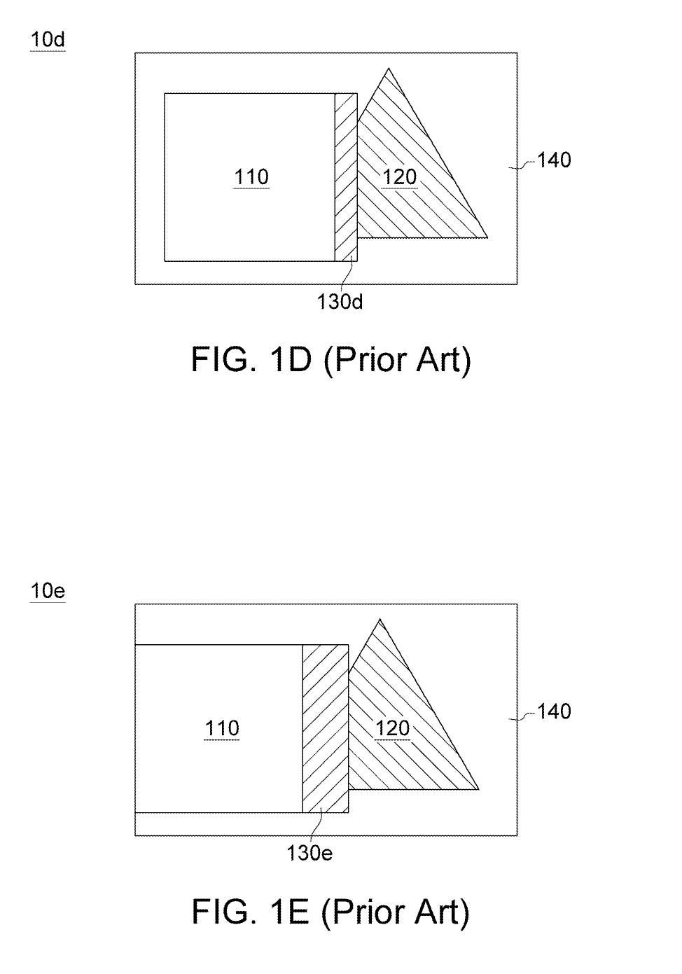

### DETAILED DESCRIPTION

In order to render or inpaint hole regions of shifted viewpoint images, a number of exemplary embodiments are disclosed to illustrate an apparatus and a method for rendering three-dimensional stereoscopic images. The apparatus is provided for rendering three-dimensional stereoscopic images. The apparatus for rendering three-dimensional stereoscopic images is used in a three-dimensional image processing system which generates a number of viewpoint images according to an input image and an input depth. The apparatus for rendering three-dimensional stereoscopic images includes an object device, a depth device, and a block filling device. The object device outputs contour information according to the input image. The depth device outputs distance information according to the input depth. The block filling device detects a hole region in each viewpoint image, searches a search region adjacent to the hole region for a number of original pixels, and fills the hole region according to the original pixels, the contour information, and the distance information.

The method for rendering three-dimensional stereoscopic images is used in a three-dimensional image processing system which generates a number of viewpoint images according to an input image and an input depth. The method includes a number of steps. A hole region in each of the viewpoint images is detected. A process of object detection is executed to output contour information according to the input image. A process of object judgment is detected to output distance information according to the input depth. A search region adjacent to the hole region is researched for a number of original pixels. The hole region is filled according to the original pixels, the contour information, and the distance information.

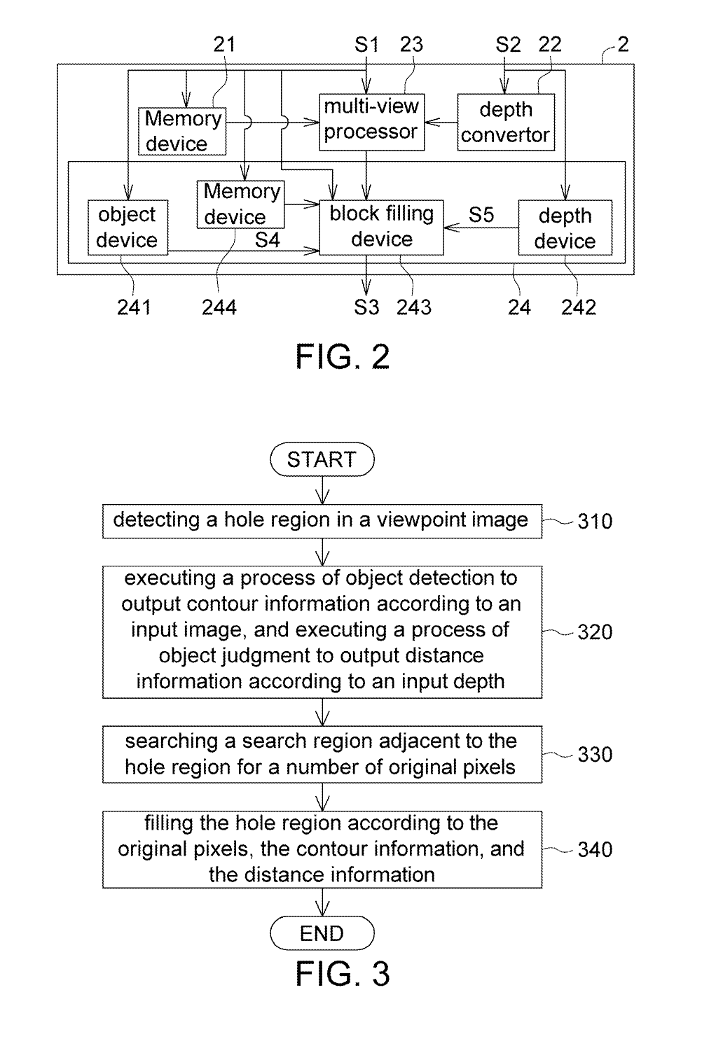

Refer to both FIG. 2 and FIG. 3. FIG. 2 is a block diagram showing an exemplary embodiment of a three-dimensional image processing system. FIG. 3 is a flow chart showing a method for rendering three-dimensional stereoscopic images according to an exemplary embodiment. The three-dimensional image processing system 2 includes a memory device 21, a depth convertor 22, a multi-view processor 23, and an apparatus 24 for rendering three-dimensional stereoscopic images. The apparatus 24 includes an object device 241, a depth device 242, and a block filling device 243. The memory device 21 stores the information of an input image S1. The depth convertor 22 converts an input depth S2 into different pixel shifts according to different viewing angles, and outputs the converted results to the multi-view processor 23. Based on the pixel shifts, the multi-view processor 23 outputs a number of viewpoint images to the block filling device 243. The block filling device 243 is operated with respect to the object device 241 as well as the depth device 242 for filling hole regions in the viewpoint images, thus outputting a filled output image S3.

As to the implementation of the apparatus 24 for rendering three-dimensional stereoscopic images, its contained circuit elements such as the object device 241, the depth device 242, and the block filling device 243 each can be realized by using a processor such as a digital signal processor (DSP), or an application-specific integrated circuit (ASIC) which is designed to perform the specific operation of such device. In another embodiment, the object device 241, the depth device 242, and the block filling device 243 each can be implemented in one or more digital or analog circuit elements, or be implemented in a field-programmable gate array (FPGA). In another embodiment, the apparatus 24 for rendering three-dimensional stereoscopic images can be implemented in an ASIC or an equivalent as a whole, while some or all of its elements can be embodied as software such as a series of programs, threads, or commands which, when operated in a computer-implemented apparatus, direct the apparatus to perform specific process or operation.

For filling the hole regions in the viewpoint images, the apparatus 24 executes a method of rendering three-dimensional stereoscopic images exemplified as follows. As shown in step 310, a hole region is detected in a viewpoint image. For example, based on the input image S1 the block filling device 243 determines should a received pixel value be classified as a hole information or an image information. If the received pixel value belongs to an image information, the received pixel value is directly outputted. If the received pixel value belongs to a hole information, it will be rendered by executing subsequent steps. After discovering the hole region, the block filling device 241 records the number or location of hole pixels in the hole region, so as to facilitate the image rendering thereafter.

As shown in step 320, the object device 241 executes a process of object detection to output contour information S4 according to the input image 51. The depth device 242 executes a process of object judgment to output distance information S5 according to the input depth S2. The contour information S4 is for example edges of the object which the object device 241 extracts from the input image S1 when applying edge detection thereto. The distance information S5 is for example distances between objects and background or distances among objects which the depth device 242 retrieves from the input depth S2. The aforementioned process of object detection which object device 241 performs on the input image S1 is, for example, implemented as using an object's edges to separate or distinguish from the object and the background. Because the object device 241 is unable to provide the distances between objects and background or distances among objects, the depth device 242 is used to collaborate in performing on the input depth the process of object judgment. It can be found that the objects corresponding to similar depths have approximate pixel values. Thus, in order for the hole region to be filled thereafter, the object device 241 can collaborate with the depth device 242 to provide the block filling device 243 with the contour information S4 and the distance information S5.

As shown in step 330, the block filling device 243 searches a search region adjacent to the hole region for a number of original pixels. In an embodiment, the apparatus 24 can, for example, further include a block buffer for temporarily storing original pixel values of the aforementioned original pixels. The research region can be exemplarily implemented as having a predefined range, or a range dynamically varied with the number of hole pixels in the hole region.

As shown in step 340, the block filling device 243 fills the hole region according to the original pixels, the contour information S4, and the distance information S5. According to the original pixels, the contour information S4, and the distance information S5, the block filling device 243 can classify as an object or a background each hole pixel in the hole region. As such, the block filling device 243 can fill a hole pixel of the hole region with a background pixel value or an object pixel value. Specifically, the aforementioned method for rendering three-dimensional stereoscopic images can further be embodied in different modes, such as a mode with memory device and a mode without memory device, description of which is provided as follows.

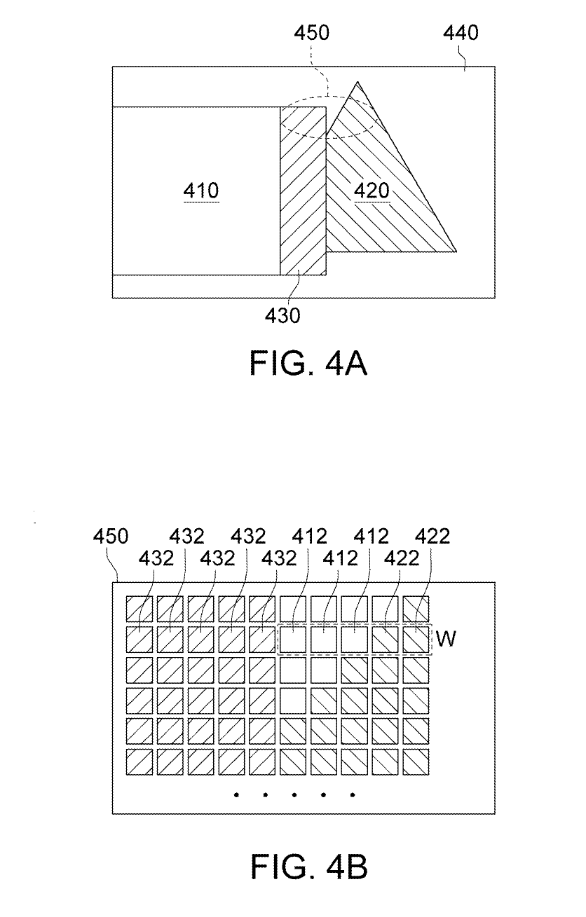

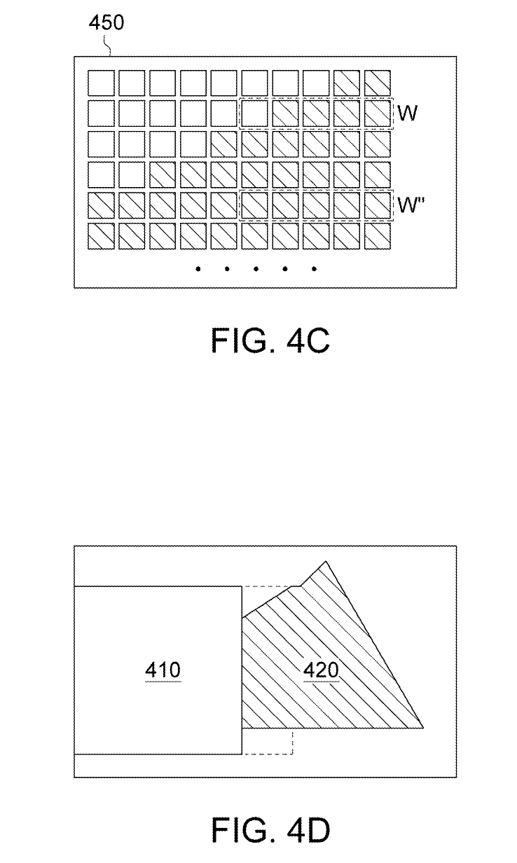

Refer to FIG. 4A, 4B, 4C, and 4D. FIG. 4A is a schematic diagram showing a viewpoint image where holes are generated after the shift of the input image. FIG. 4B is a partially enlarged diagram showing a selected portion 450 in FIG. 4A. FIG. 4C is a partially enlarged diagram showing the selected portion in FIG. 4B where the hole region is filled by proportionate expansion. FIG. 4D is a schematic diagram showing a viewpoint image in FIG. 4A where the hole region is filled by proportionate expansion. For example, the original viewpoint image 4a has the selected portion 450 partially enlarged as a partial viewpoint image 4b. When having detected a number of hole pixels 432 in the hole region 430 of the viewpoint image 4a, the aforementioned block filling device 243 determines whether each original pixel in the search region W belongs to an object 420 or a background 440. An original pixel being determined as the object 420 is referred to as an object pixel 422, while an original pixel being determined as the background 440 is referred to as a background pixel 412. In an embodiment, the original pixels in the search region W correspond to an object-background ratio which is indicative of the ratio between the numbers of the object pixels and the background pixels. As shown in FIG. 4B, exemplarily, there are two object pixels 422 and three background pixels 412 in the search region W, which correspond to an object-background ratio of 2:3. In other words, the object-background ratio of 2:3 means a composition of two object pixel values and three background pixel values can be found in five original pixel values.

According to the object-background ratio, the block filling device 243 proportionately expands the five original pixel values which contain two object pixel values and three background pixel values in a manner of filling hole pixels 432, the object pixels 422, and the background pixels 412 in FIG. 4B. In this way of rendering, the generated result is a partial viewpoint image 4c shown in FIG. 4C. After being rendered by proportionate expansion, the original viewpoint image 4a in FIG. 4A is converted into a filled viewpoint image 4d in FIG. 4D. The number of the hole pixels 432 and the size of the search region W are associated with the performance of image rendering. When the search region is larger, better performance of image rendering can be obtained while a larger amount of data is required to be temporally stored. Correspondingly, when the search region is smaller, minor performance of image rendering can be obtained while a smaller amount of data is required to be temporally stored. In addition to the aforementioned embodiment where the hole region is filled by proportionate expansion, in other embodiments, the block filling device 243 can fill hole pixels of the hole region according to an average value of the original pixel values. In another embodiments, the block filling device 243 can fill the hole pixels of the hole region by duplicating the original pixel values, or fill the hole pixels of the hole region by duplicating a computation result of the original pixel values.

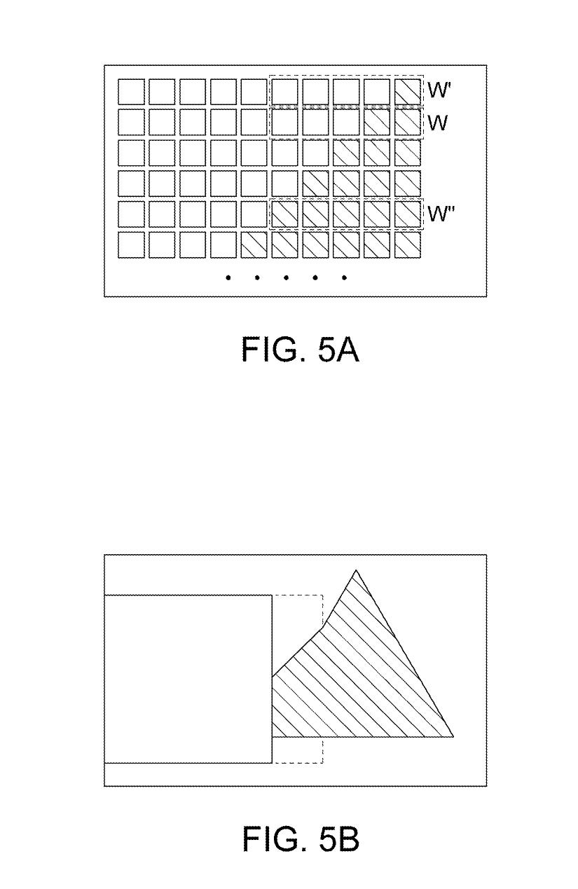

Refer to both FIG. 5A and FIG. 5B. FIG. 5A is a schematic diagram showing the selected portion in FIG. 4B where the hole region is filled by using a variation criteria of the object. FIG. 5B is a schematic diagram showing a viewpoint image in FIG. 4A where the hole region is filled by using the variation criteria of the object. The apparatus 24 for rendering three-dimensional stereoscopic images can further include a memory device 244 for storing reference pixel values. The reference pixel values in a following embodiment are exemplified as being located at an upper row of the original pixels, but this disclosure is not limited thereto. The memory 244, also, can be used to store another one or more rows of pixel values, and serve them the reference pixel values. The reference pixel values correspond to a number of reference pixels, respectively. For example, as shown in FIG. 5A, the reference pixels are located in the search region W′. From the reference pixels in the search region W′ and the original pixels in the search region W, the block filling device 243 can determine a variation criteria of the object, and fills the hole pixels according to the variation criteria. In other embodiments, the aforementioned memory 244 can further include the block buffer which is for temporarily storing the aforementioned original pixel values of the original pixels.

In the mode with memory, the block filling device 243 applies, for example, an upper row of reference pixels to determining the required pixel values of the hole pixels. As shown in FIG. 5A, from the search regions W′ to W, the number of background pixels is changed from four to three, while the number of object pixels is changed from one to two. From the variation criteria of the object, the block filling device 243 can derive that the number of the object pixels is increasing regularly. Au such, when rendering pixels on the left side of the search region W in FIG. 4B, the block filling device 243 fills the five hole pixels 432 by extending the background pixel values of the three background pixels 412 in the search region W. By using the variation criteria of the object in image rendering, the filled image can be the one shown in FIG. 5B. Besides, in other embodiments, the block filling device 243 can also apply reference pixels in the search region W′ and an object-background ration in the search region W to filling the hole pixels and the original pixels by proportionate expansion. Moreover, in other embodiments, the block filling device 243 can apply the reference pixels to filling the hole pixels by duplicating the original pixels.

As mentioned above, a number of embodiments are exemplified for illustration of the present disclosure. As long as there are cases where the block filling device can fill the hole region according to the contour information of the object device and the distance information of the depth device, they are also regarded as practicable and feasible embodiments of the disclosure, and the claimed subject matter will reach them.

While the disclosure has been described by way of example and in terms of the preferred embodiment(s), it is to be understood that the disclosure is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An apparatus for rendering three-dimensional stereoscopic images, the apparatus being used in a three-dimensional image processing system, the three-dimensional image processing system generating a plurality of viewpoint images according to an input image and an input depth, the apparatus comprising
an object device configured to execute a process of object detection to output contour information according to the input image;
a depth device configured to execute a process of object judgment to output distance information according to the input depth, and
a block filling device configured to detect a hole region in each of the viewpoint images, searching a search region adjacent to the hole region for a number of original pixels, filling the hole region according to the original pixels, the contour information, and the distance information.

2. The apparatus according to claim 1, wherein the block filling device classifies as an object or a background each of a plurality of hole pixels in the hole region according to the original pixels, the contour information, and the distance information.

3. The apparatus according to claim 1, wherein the block filling device fills a plurality of hole pixels of hole region and the original pixels by proportionately expanding a plurality of original pixel values of the original pixels according to an object-background ratio of the original pixels.

4. The apparatus according to claim 1, wherein the block filling device fills a plurality of hole pixels of the hole region according to an average value of a plurality of original pixel values of the original pixels.

5. The apparatus according to claim 1, wherein the block filling device fills a plurality of hole pixels of the hole region by duplicating a plurality of original pixel values of the original pixels, or fills the hole pixels of the hole region by duplicating a computation result of the original pixel values.

6. The apparatus according to claim 1, further comprising:
a memory device configured to store a plurality of reference pixel values, the reference pixel values respectively corresponding to a plurality of reference pixels, the reference pixels being adjacent to the original pixels.

7. The apparatus according to claim 6, wherein the block filling device determines a variation criteria of the object from the reference pixels and the original pixels, and fills a plurality of hole pixels of the hole region according to the variation criteria.

8. The apparatus according to claim 6, wherein the block filling device applies the reference pixels to filling a plurality of hole pixels of hole region and the original pixels by proportionately expanding a plurality of original pixel values of the original pixels according to an object-background ratio of the original pixels.

9. The apparatus according to claim 6, wherein the block filling device applies the reference pixels to filling a plurality of hole pixels of the hole region by duplicating a plurality of original pixel values of the original pixels.

10. The apparatus according to claim 6, wherein the memory device further comprises:
a block buffer configured to temporally store a plurality of original pixel values of the original pixels.

11. The apparatus according to claim 1, wherein the research region has a range dynamically varied with the number of hole pixels in the hole region.

12. The apparatus according to claim 1, wherein the search region has a predefined range.

13. A method for rendering three-dimensional stereoscopic images, the method being used in a three-dimensional image processing system, the three-dimensional image processing system generating a plurality of viewpoint images according to an input image and an input depth, the method comprising:
detecting a hole region in each of the viewpoint images;
executing a process of object detection to output contour information according to the input image;
executing a process of object judgment to output distance information according to the input depth,
searching a search region adjacent to the hole region for a number of original pixels; and
filling the hole region according to the original pixels, the contour information, and the distance information.

14. The method according to claim 13, wherein in the step of filling the hole region, each of a plurality of hole pixels in the hole region is classified as an object or a background according to the original pixels, the contour information, and the distance information.

15. The method according to claim 13, wherein in the step of filling the hole region, a plurality of hole pixels in hole region and the original pixels are filled by proportionately expanding a plurality of original pixel values of the original pixels according to an object-background ratio of the original pixels.

16. The method according to claim 13, wherein in the step of filling the hole region, a plurality of hole pixels in the hole region are filled according to an average value of a plurality of original pixel values of the original pixels.

17. The method according to claim 13, wherein in the step of filling the hole region, a plurality of hole pixels in the hole region are filled by duplicating a plurality of original pixel values of the original pixels, or filled by duplicating a computation results of the original pixel values.

18. The method according to claim 13, wherein further comprising:
storing a plurality of reference pixel values, the reference pixel values respectively corresponding to a plurality of reference pixels.

19. The method according to claim 18, wherein in the step of filling the hole region, a variation criteria of the object is determined from the reference pixels and the original pixels, and a plurality of hole pixels in the hole region are filled according to the variation criteria.

20. The method according to claim 18, wherein in the step of filling the hole region, the reference pixels are applied to filling a plurality of hole pixels of the hole region and the original pixels by proportionately expanding a plurality of original pixel values of the original pixels according to an object-background ratio of the original pixels.

21. The method according to claim 18, wherein in the step of filling the hole region, the reference pixels are applied to filling a plurality of hole pixels of the hole region by duplicating a plurality of original pixel values of the original pixels.

22. The method according to claim 13, further comprising:
storing, temporally, a plurality of original pixel values of the original pixels.

23. The method according to claim 22, wherein the research region has a range dynamically varied with the number of hole pixels in the hole region.

24. The method according to claim 22, wherein the search region has a predefined range.
